(19) United States
(12) Patent Application Publication
(10) Pub. No.: US 2009/0244097 A1
(43) Pub. Date: Oct. 1, 2009

(54) System and Method for Providing Augmented Reality

(76) Inventor: Leonardo William Estevez, Rowlett, TX (US)

Correspondence Address: TEXAS INSTRUMENTS INCORPORATED, P O BOX 655474, M/S 3999, DALLAS, TX, 75265, US

(21) Appl. No.: 12/055,116

(22) Filed: Mar. 25, 2008

(51) Int. Cl. G09G 5/00; G01S 3/02

(52) U.S. Cl. 345/633; 342/450

(57) ABSTRACT

A system and method for providing augmented reality. A method comprises retrieving a specification of an environment of the electronic device, capturing optical information of the environment of the electronic device, and computing the starting position/orientation from the captured optical information and the specification. The use of optical information in addition to positional information from a position sensor to compute the starting position may improve a viewer's experience with a mobile augmented reality system.

### TECHNICAL FIELD

The present invention relates generally to a system and method for displaying images, and more particularly to a system and method for providing augmented reality.

### BACKGROUND

In general, augmented reality involves a combining of computer generated objects (or virtual objects) with images containing real objects and displaying the images for viewing purposes. Augmented reality systems usually have the capability of rendering images that change with a viewer's position. The ability to render images that change with the viewer's position requires the ability to determine the viewer's position and to calibrate the image to the viewer's initial position.

Commonly used techniques to determine a viewer's position may include the use of an infrastructure based positioning system, such as the global positioning system (GPS) or terrestrial beacons that may be used to enable triangulation or trilatteration. However, GPS based systems generally do not work well indoors, while systems utilizing terrestrial beacons do not scale well as the systems increase in size due to the investment required in the terrestrial beacons. Furthermore, these techniques typically do not provide orientation information as well as height information.

### SUMMARY OF THE INVENTION

These and other problems are generally solved or circumvented, and technical advantages are generally achieved, by embodiments of a system and a method for providing augmented reality.

In accordance with an embodiment, a method for calculating a starting position/orientation of an electronic device is provided. The method includes retrieving a specification of an environment of the electronic device, capturing optical information of the environment of the electronic device, and computing the starting position/orientation from the captured optical information and the specification.

In accordance with another embodiment, a method for displaying an image using a portable display device is provided. The method includes computing a position/orientation for the portable display device, rendering the image using the computed position/orientation for the portable display device, and displaying the image. The method also includes in response to a determining that the portable display device has changed position/orientation, computing a new position/orientation for the portable display device, and repeating the rendering and the displaying using the computed new position/orientation. The computing makes use of optical position information captured by an optical sensor in the portable display device.

In accordance with another embodiment, an electronic device is provided. The electronic device includes a projector configured to display an image, a position sensor configured to provide position and orientation information of the electronic device, an optical sensor configured to capture optical information for use in computing a position and orientation of the electronic device, and a processor coupled to the projector, to the position sensor, and to the optical sensor. The processor processes the optical information and the position and orientation information to compute the position and orientation of the electronic device and renders the image using the position and orientation of the electronic device.

An advantage of an embodiment is that no investment in infrastructure is required. Therefore, a mobile augmented reality system may be made as large as desired without incurring increased infrastructure cost.

A further advantage of an embodiment is that if some of the position/orientation determination systems, such as positioning hardware, are not in place, other position/orientation determination systems may be used that may not require the positioning hardware in their place. This enables a degree of flexibility as well as fault tolerance typically not available in mobile augmented reality systems.

Yet another advantage of an embodiment is the hardware requirements are modest and may be made physically small. Therefore, the mobile augmented reality system may also be made small and easily portable.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a mobile augmented reality system;

FIG. 2 is a diagram of an electronic device;

FIG. 3a is a diagram of an algorithm for use in rendering and displaying an image in a mobile augmented reality system;

FIG. 3b is a diagram of a sequence of events for use in determining a starting position/orientation of an electronic device;

FIG. 4a is an isometric view of a room of a mobile augmented reality system;

FIG. 4b is a data plot of luminosity for a room of a mobile augmented reality system;

FIG. 5 is a diagram of a sequence of events for use in determining a starting position/orientation of an electronic device using luminosity information;

FIG. 6a is an isometric view of a room of a mobile augmented reality system;

FIG. 6b is a top view of a room of a mobile augmented reality system;

FIG. 7 is a diagram of a sequence of events for use in determining a starting position/orientation of an electronic device using measured angles between an electronic device and objects;

FIG. 8a is a diagram of an electronic device that makes use of hyperspectral imaging to determine position/orientation;

FIG. 8b is a diagram of an electronic device that makes use of hyperspectral imaging to determine position/orientation; and

FIG. 9 is a diagram of a sequence of events for use in determining a starting position/orientation of an electronic device using hyperspectral information.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely an electronic device capable of displaying images. The images being displayed may contain virtual objects that are generated by the electronic device. The images displayed as well as any virtual objects are rendered based on a viewer's position and orientation, with the viewer's position and orientation being determined using hardware and software resources located in the electronic device. Additional position and orientation information may also be provided to the electronic device. The images may be displayed using a digital micromirror device (DMD). The invention may also be applied, however, to electronic devices wherein the determining of the viewer's position and orientation may be performed partially in the electronic device and partially using an external positioning infrastructure, such as a global positioning system (GPS), terrestrial beacons, and so forth. Furthermore, the invention may also be applied to electronic devices using other forms of display technology, such as transmissive, reflective, and transflective liquid crystal, liquid crystal on silicon, ferroelectric liquid crystal on silicon, deformable micromirrors, scan mirrors, and so forth.

With reference now to FIG. 1, there is shown a diagram illustrating an isometric view of a mobile augmented reality system 100. The mobile augmented reality system 100 may comprise one or more rooms (or partial rooms), such as a room 105. The room 105 includes a ceiling 110, a floor 115, and several walls, such as wall 120, 122, 124. The room 105 may include real objects, such as real object 125 and 127. Examples of real objects may include furniture, pictures, wall hangings, carpets, and so forth. Other examples of real objects may include living things, such as animals and plants.

The mobile augmented reality system 100 includes an electronic device 130. The electronic device 130 may be sufficiently small so that a viewer may be able to carry the electronic device 130 as the viewer moves through the mobile augmented reality system 100. The electronic device 130 may include position/orientation detection hardware and software, as well as an image projector that may be used to project images to be used in the mobile augmented reality system 100. Since the electronic device 130 may be portable, the electronic device 130 may be powered by a battery source. A more detailed description of the electronic device 130 is provided below.

The mobile augmented reality system 100 also includes an information server 135. The information server 135 may be used to communicate with the electronic device 130 and provide the electronic device 130 with information such as a layout of the room 105, the location of real objects and virtual objects, as well as other information that may be helpful in improving the experience of the viewer. If the mobile augmented reality system 100 includes multiple rooms, each room may have its own information server. Preferably, the information server 135 communicates with the electronic device 130 over a wireless communications network having limited coverage. The wireless communications network may have limited operating range so that transmissions from information servers that are operating in close proximity do not interfere with one another. Furthermore, the information server 135 may be located at an entrance or exit of the room 105 so that the electronic device 130 may detect the information server 135 or the information server 135 may detect the electronic device 130 as the electronic device 130 enters or exits the room 105. Examples of wireless communications networks may include radio frequency identification (RFID), IEEE 802.15.4, IEEE 802. 11, wireless USB, or other forms of wireless personal area network.

An image created and projected by the electronic device 130 may be overlaid over the room 105 and may include virtual objects, such as virtual object 140 and 142. Examples of virtual objects may include anything that may be a real object. Additionally, virtual objects may be objects that do not exist in nature or objects that no longer exist. The presence of the virtual objects may further enhance the experience of the viewer.

As the viewer moves and interacts with objects in the room 105 or as the viewer moves between rooms in the mobile augmented reality system 100, the electronic device 130 may be able to detect changes in position/orientation of the electronic device 130 (and the viewer) and renders and displays new images to overlay the room 105 or other rooms in the mobile augmented reality system 100. In addition to moving and interacting with objects in the room 105, the viewer may alter the view by zooming in or out. The electronic device 130 may detect changes in the zoom and adjust the image accordingly.

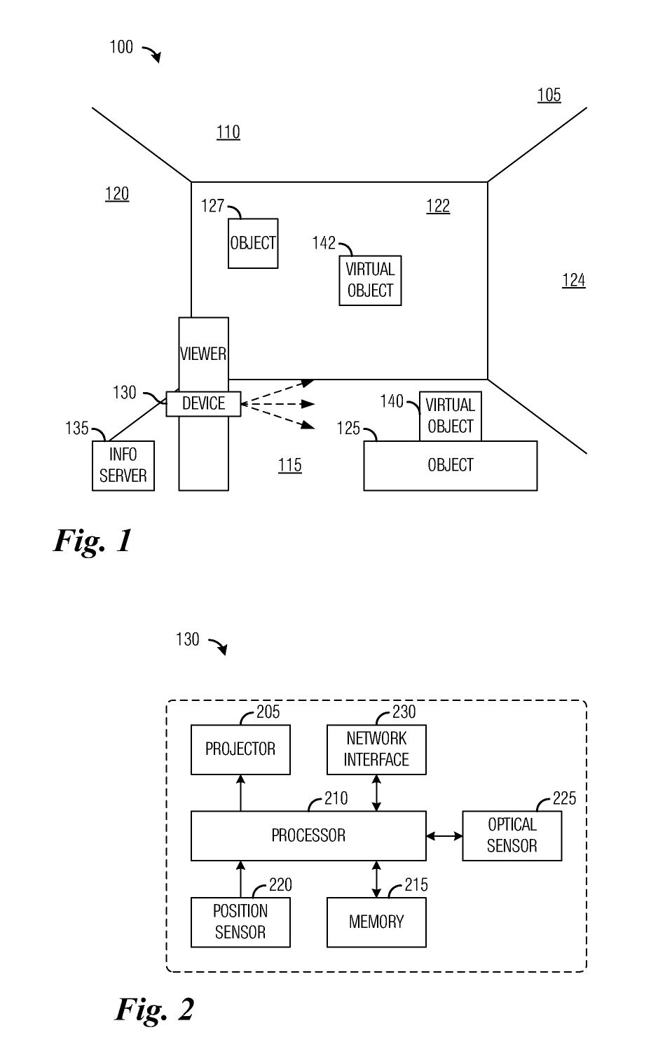

FIG. 2 illustrates a detailed view of an electronic device that may be used in a mobile augmented reality system. FIG. 2 illustrates a detailed view of an electronic device, such as the electronic device 130, that may be used to render and project images in a mobile augmented reality system, such as the mobile augmented reality system 100. The electronic device 130 includes a projector 205 that may be used to display the images. The projector 205 may be a microdisplay-based projection display system, wherein the microdisplay may be a DMD, a transmissive or reflective liquid crystal display, a liquid crystal on silicon display, ferroelectric liquid crystal on silicon, a deformable micromirror display, or another microdisplay.

The projector 205 may utilize a wideband light source (for example, an electric arc lamp), a narrowband light source (such as a light emitting diode, a laser diode, or some other form of solid-state illumination source). The projector 205 may also utilize a light that may be invisible to the naked eye, such as infrared or ultraviolet. These invisible lights and images created by the lights may be made visible if the viewer wears a special eyewear or goggle, for example. The projector 205 and associated microdisplay, such as a DMD, may be controlled by a processor 210. The processor 210 may be responsible for issuing microdisplay commands, light source commands, moving image data into the projector 205, and so on. A memory 215 coupled to the processor 210 may be used to store image data, configuration data, color correction data, and so on.

In addition to issuing microdisplay commands, light source commands, moving image data into the projector 205, and so on, the processor 210 may also be used to render the images displayed by the projector 205. For example, the processor 210 may render virtual objects, such as the virtual objects 140 and 142, into the image. The processor 210 may make use of positional/orientation information provided by a position sensor 220 in the rendering of the image. The position sensor 220 may be used to detect changes in position/orientation of the electronic device 130 and may include gyroscopic devices, such as accelerometers (tri-axial as well as others), angular accelerometers, and so on, non-invasive detecting sensors, such as ultrasonic sensors, and so forth, inductive position sensors, and so on, that may detect motion (or changes in position). Alternatively, the position sensor 220 may include other forms of position sensors, such as an electronic compass (ecompass), a global positioning system (GPS) sensor or sensors using terrestrial beacons to enable triangulation or trilatteration that may be used to detect changes in location/orientation of the electronic device 130 or may be used in combination with the gyroscopic devices and others, to enhance the performance of the sensors.

The electronic device 130 also includes an optical sensor 225 that may be used to also determine the position/orientation information of the electronic device 130 using techniques different from the position sensors in the position sensor 120. For example, the optical sensor 225 may be light intensity sensors that may be used to generate luminosity information of a room, such as the room 105, to determine the position/orientation of the electronic device 130 in the room 105. Alternatively, the optical sensor 225 may be optical sensors capable of measuring relative angles between the electronic device 130 and known positions or objects in the room 105, such as intersections of the ceiling 110 or floor 115 with one or more walls 120, 122, or 124, objects 125 and 127, and so forth. The relative angles may then be used to determine the position/orientation of the electronic device 130 in the room 105. In yet another alternative embodiment, the optical sensor 225 may be a series of narrow band sensors capable of measuring hyperspectral signatures of the room 105. From the hyperspectral signatures, the position/orientation of the electronic device 130 may be determined. The position/orientation information provided through the use of the optical sensor 225 may be used in conjunction with or in lieu of position/orientation information provided by the position sensor 210. A detailed description of the use of the optical sensor 225 to determine relative position/orientation is provided below.

The position/orientation information provided by the position sensor 220 may be used to determine the position/orientation of the electronic device 130. However, it may also be possible to also make use of the information provided by the optical sensor 225 in combination with the position/orientation information provided by the position sensor 220 to determine the position/orientation of the electronic device 130 to achieve a more accurate determination of the position/orientation of electronic device 130. Alternative, the information provided by the optical sensor 225 may be used to determine the position/orientation of the electronic device 130 without a need for the positional/orientation information provided by the position sensor 220. Therefore, it may be possible to simplify the design as well as potentially reduce the cost of the electronic device 130.

The electronic device 130 may also include a network interface 230. The network interface 230 may permit the electronic device 130 to communicate with the information server 135 as well as other electronic devices. The communications may occur over a wireless or wired network. For example, the network interface 230 may allow for the electronic device 130 to retrieve information pertaining to the room 105 when the electronic device 130 initially moves into the room 105, or when the electronic device 130 pans to a previously unseen portion of the room 105. Additionally, the network interface 230 may permit the electronic device 130 to network with other portable electronic devices and permit viewers of the different devices to see what each other are seeing. This may have applications in gaming, virtual product demonstrations, virtual teaching, and so forth.

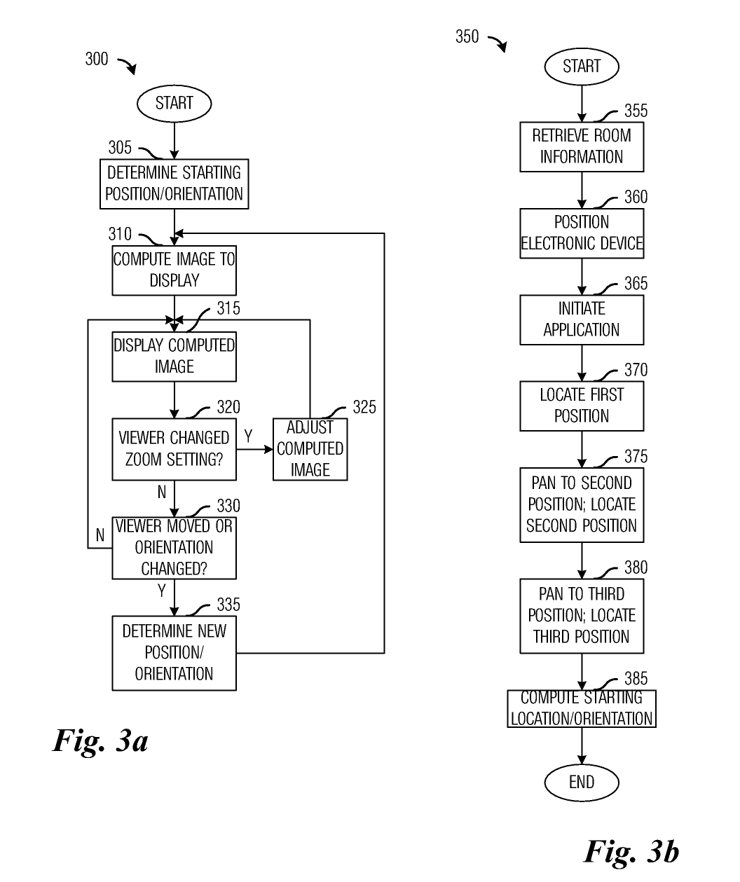

FIG. 3a illustrates a high level diagram of an algorithm 300 for use in rendering and displaying an image for a mobile augmented reality system, such as the mobile augmented reality system 100. The algorithm 300 may make use of position/orientation information provided by the position sensor 220, as well as information provided by the optical sensor 225, to compute a position/orientation of the electronic device 130. Although the algorithm 300 may make use of both the position/orientation information from the position sensor 220 and the information provided by the optical sensor 225 to determine the position/orientation of the electronic device 130, the algorithm 300 may also be able to determine the position/orientation of the electronic device 130 solely from the information provided by the optical sensor 225. The computed position and orientation of the electronic device 130 may then be used in the rendering and displaying of the image in the mobile augmented reality system 100.

The rendering and displaying of images in the mobile augmented reality system 100 may begin with a determining of a starting position/orientation (block 305). The starting position/orientation may be a specific position and orientation in a room, such as the room 105, in the mobile augmented reality system 100. For example, for the room, the starting position/orientation may be at a specified corner of the room with an electronic device, such as the electronic device 130, pointing at a specified target. Alternatively, the starting position/orientation may not be fixed and may be determined using positional and orientation information.

FIG. 3b illustrates a sequence of events 350 for use in determining a starting position/orientation of the electronic device 130. The sequence of events 350 may be an embodiment of the determining of a starting position/orientation block in the sequence of events 300 for use in rendering and displaying of images in the mobile augmented reality system 100. The determining of the starting position/orientation of the electronic device 130 may begin when a viewer holding the electronic device 130 enters the room 105 or when the information server 135 detects the electronic device 130 as the viewer holding the electronic device 130 approaches an entry into the room 105 (or vice versa). Until the determination of the starting position/orientation of the electronic device 130 is complete, the position/orientation of the electronic device 130 remains unknown.

After the information server 135 detects the electronic device 130, a wireless communications link may be established between the two and the electronic device 130 may be able to retrieve information pertaining to the room 105 (block 355). The information that the electronic device 130 may be able to retrieve from the information server 135 may include a layout of the room 105, including dimensions (length, for example) of walls in the room 105, the location of various objects (real and/or virtual) in the room 105, as well as information to help the electronic device 130 determine the starting position/orientation for the electronic device 130. The information to help the electronic device 130 determine the starting/position may include number, location, type, and so forth, of desired targets in the room 105, and so on. The desired targets in the room 105 may be targets having fixed position, such as floor or ceiling corners of the room, as well as doors, windows, and so forth. For example, the desired targets may be three points defining two intersecting walls and their intersection, i.e., the three points may define the corners of the two intersecting walls and their intersection.

With the information retrieved (block 355), the viewer may initiate the determining of the starting position/orientation of the electronic device 130. The viewer may start by holding or positioning the electronic device 130 as he/she would be holding it while normally using the electronic device 130 (block 360) and then initiating an application to determine the starting position/orientation of the electronic device (block 365). The electronic device 130 may be assumed to be held at a distance above the ground, for example, five feet for a view of average height. The viewer may initiate the application by pressing a specified button or key on the electronic device 130. Alternatively, the viewer may enter a specified sequence of button presses or key strokes.

Once the application is initiated, the viewer may locate a first desired target in the room 105 using electronic device 130 (block 370). For example, the first desired target may be a first corner of a first wall. The electronic device 130 may include a view finder for use in locating the first desired target. Alternatively, the electronic device 130 may display a targeting image, such as cross-hairs, a point, or so forth, to help the viewer locate the first desired target. To further assist the viewer in locating the first desired target, the electronic device 130 may display information related to the first desired target, such as a description (including verbal and/or pictorial information) of the first desired target and potentially where to find the first desired target. Once the viewer has located the first desired target, the viewer may press a key or button on the electronic device 130 to notify the electronic device 130 that the first desired target has been located.

With the first desired target located (block 370), the electronic device 130 may initiate the use of a sum of absolute differences (SAD) algorithm. The SAD algorithm may be used for motion estimation in video images. The SAD algorithm takes an absolute value of differences between pixels of an original image and a subsequent image to compute a measure of image similarity. The viewer may pan the electronic device 130 to a second desired target (block 375). For example, the second desired target may be a corner at an intersection of the first wall and a second wall. Once again, the electronic device 130 may provide information to the viewer to assist in locating the second desired target. As the viewer pans the electronic device 130 to the second desired target, the optical sensor 225 in the electronic device 130 may be capturing optical information for use in determining the starting position/orientation of the electronic device 130. Examples of optical information may include luminosity information, visual images for use in measuring subtended angles, hyperspectral information, and so forth.

The electronic device 130 may provide feedback information to the viewer to assist in the panning to the second desired target. For example, the electronic device 130 may provide feedback information to the viewer to help the viewer maintain a proper alignment of the electronic device 130, a proper panning velocity, and so forth.

Once the viewer locates the second desired target, the viewer may once again press a button or key to on the electronic device 130 to notify the electronic device 130 that the second desired target has been located. After locating the second desired target, the viewer may pan the electronic device 130 to a third desired target (block 380). For example, the third desired target may be a corner of the second wall. Once again, the electronic device 130 may provide information to the viewer to assist in locating the third desired target. After the viewer locates the third desired target (block 380), the starting position/orientation of the electronic device 130 may then be computed by the electronic device 130 (block 385).

The computing of the starting position/orientation of the electronic device 130 may make use of a counting of a total number of pixels scanned by the optical sensor 225 of the electronic device 130 as it panned from the first desired target to the second desired target to the third desired target. The total number of pixels scanned by the optical sensor 225 may be dependent upon factors such as the optical characteristics of the optical sensor 225, as well as optical characteristics of any optical elements used to provide optical processing of light incident on the optical sensor 225, such as focal length, zoom/magnification ratio, and so forth. The computing of the starting position/orientation of the electronic device 130 may also make use of information downloaded from the information server 135, such as the physical dimensions of the room 105. The physical dimensions of the room 105 may be used to translate the optical distance traveled (the total number of pixels scanned by the optical sensor 225) into physical distance. Using this information, the electronic device 130 may be able to compute its starting position/orientation as a distance from the first wall and the second wall, for example.

Turning back now to FIG. 3a, with the starting position/orientation determined, the electronic device 130 may then compute an image to display (block 310). The computing of the image to display may be a function of the starting position. The processor 210 may make use of the starting position/orientation to alter an image, such as an image of the room 105, to provide an image corrected to a view point of the viewer located at the reference position. In addition to altering the image, the processor 210 may insert virtual objects, such as the virtual objects 140 and 142, into the image. Furthermore, a current zoom setting of the electronic device 130 may also be used in the computing of the image. The processor 210 may need to scale the image up or down based on the current zoom setting of the electronic device 130. Once the processor 210 has completed the computing of the image, the electronic device 130 may display the image using the projector 205 (block 315).

While the electronic device 130 displays the image using the projector 205, the electronic device may check to determine if the viewer has changed the zoom setting of the electronic device (block 320). If the viewer has changed zoom setting on the electronic device 130, it may be necessary to adjust the image (block 325) accordingly prior to continuing to display the image (block 315).

The electronic device 130 may also periodically check information from the optical sensor 225 and the position sensor 220 to determine if there has been a change in position/orientation of the electronic device 130 (block 330). The position sensor 220 and/or the optical sensor 225 may be used to provide information to determine if there has been a change in position/orientation of the electronic device 130. For example, an accelerometer, such as a triaxial accelerometer, may detect if the viewer has taken a step(s), while optical information from the optical sensor 225 may be processed using the SAD algorithm to determine changes in orientation. If there has been no change in position and/or orientation, the electronic device 130 may continue to display the image (block 315). However, if there has been a change in either the position or orientation of the electronic device 130, then the electronic device 130 may determine a new position/orientation of the electronic device 130 (block 335). After determining the new position/orientation, the electronic device 130 may compute (block 310) and display (block 315) a new image to display. The algorithm 300 may continue while the electronic device 130 is in a normal operating mode or until the viewer exits the mobile augmented reality system 100.

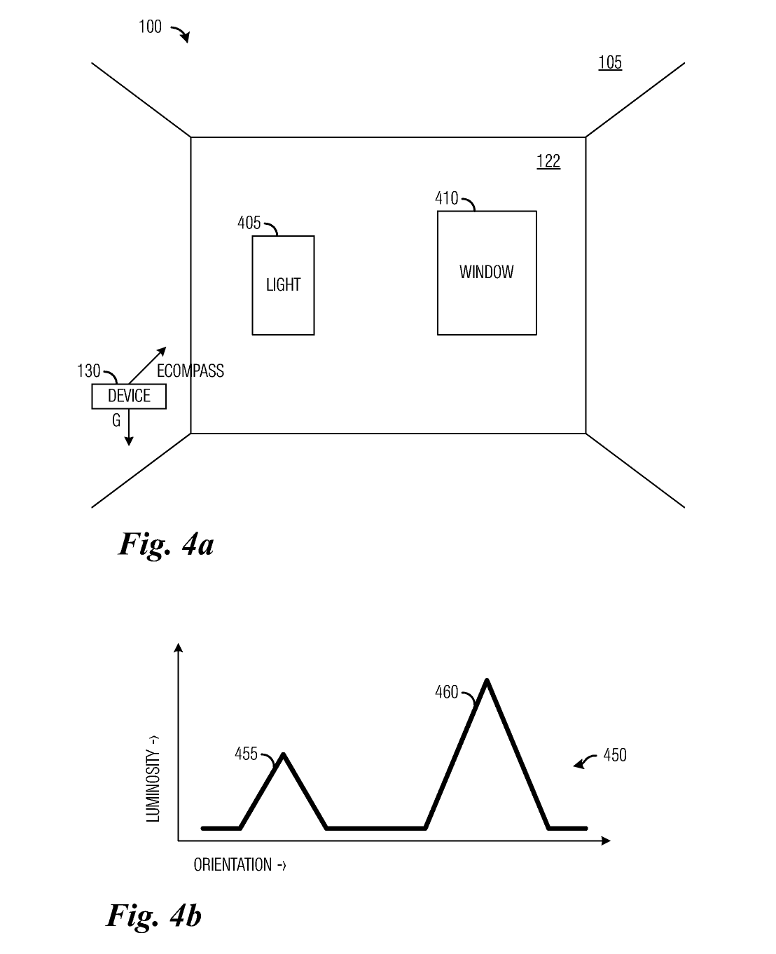

FIG. 4a illustrates an isometric view of a room, such as the room 105, of a mobile augmented reality system, such as the mobile augmented reality system 100. As shown in FIG. 4a, a wall, such as the wall 122, of the room 105 may include a light 405 and a window 410. Generally, a light (when on) and/or a window will tend to have more luminosity than the wall 122 itself. The luminosity information of the room 105 may then be used determine the position/orientation of the electronic device 130. Additionally, the position sensor 220 in the electronic device 130 may provide position/orientation information, such as from an ecompass and/or an accelerometer.

FIG. 4b illustrates a data plot of luminosity (shown as curve 450) for the wall 122 of the room 105 as shown in FIG. 4a. The luminosity of the wall (curve 450) includes two significant luminosity peaks. A first peak 455 corresponds to the light 405 and a second peak 460 corresponds to the window 410. The position of the luminosity peaks may change depending on the position/orientation of the electronic device 130. Therefore, the luminosity may be used to determine the position/orientation of the electronic device 130.

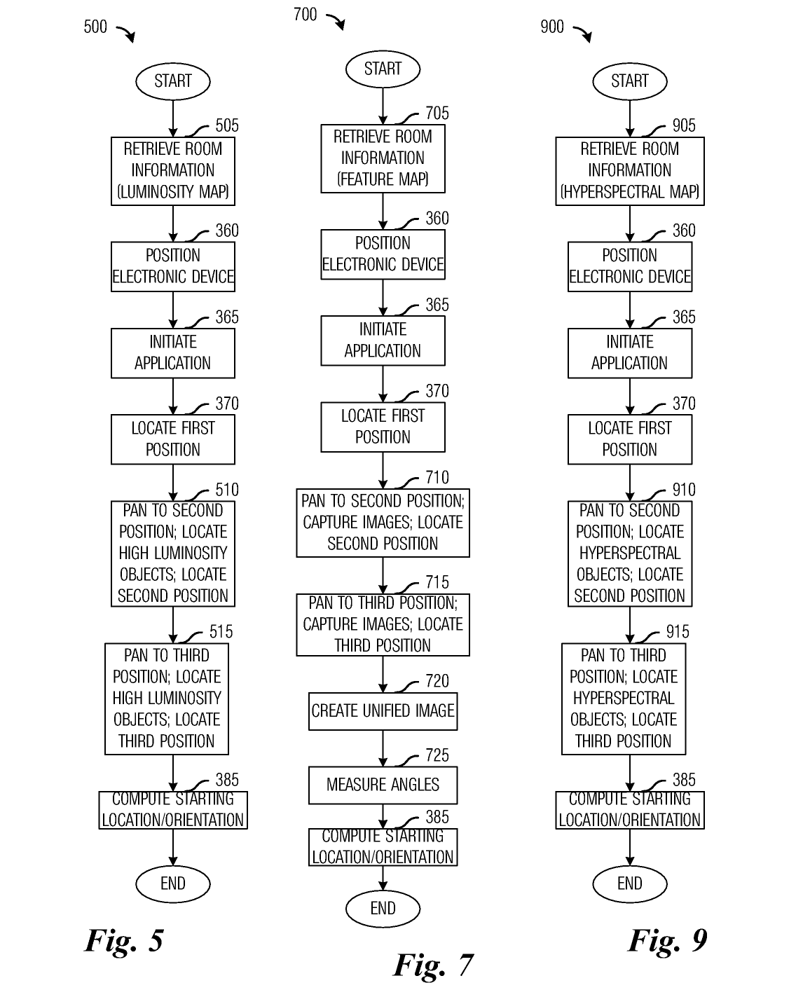

FIG. 5 illustrates a sequence of events 500 for determining a starting position/orientation using luminosity information provided by an optical sensor, such as the optical sensor 225, of an electronic device, such as the electronic device, used in a mobile augmented reality system, such as the mobile augmented reality system 100. The sequence of events 500 may be a variation of the sequence of events 350 for use in determining a starting position/orientation of the electronic device 130, making use of the room's luminosity information to help in determining the starting position/orientation of the electronic device 130.

The determining of the starting position/orientation of the electronic device 130 may begin when a viewer holding the electronic device 130 enters the room 105 or when the information server 135 detects the electronic device 130 as the viewer holding the electronic device 130 approaches an entry into the room 105 (or vice versa). Until the determination of the starting position/orientation of the electronic device 130 is complete, the position/orientation of the electronic device 130 remains unknown.

After the information server 135 detects the electronic device 130, a wireless communications link may be established between the two and the electronic device 130 may be able to retrieve information pertaining to the room 105 (block 505). The information that the electronic device 130 may be able to retrieve from the information server 135 may include a layout of the room 105, the dimensions of walls in the room 105, the location of various objects (real and/or virtual) in the room 105, as well as information to help the electronic device 130 determine the starting position/orientation for the electronic device 130. The information to help the electronic device 130 determine the starting/position may include number, location, type, and so forth, of desired targets in the room 105, and so on. The desired targets in the room 105 may be targets having fixed position, such as floor or ceiling corners of the room, as well as doors, windows, and so forth. For example, the desired targets may be three points defining two intersecting walls and their intersection, i.e., the three points may define the corners of the two intersecting walls and their intersection.

In addition to the information discussed above, the electronic device 130 may also retrieve a luminosity map of the room 105. The luminosity map may include the location of high luminosity objects in the room 105, such as windows, lights, and so forth. With the information retrieved (block 505), the viewer may initiate the determining of the starting position/orientation of the electronic device 130. The viewer may start by holding or positioning the electronic device 130 as he/she would be holding it while normally using the electronic device 130 (block 360) and then initiating an application to determine the starting position/orientation of the electronic device (block 365). The viewer may initiate the application by pressing a specified button or key on the electronic device 130. Alternatively, the viewer may enter a specified sequence of button presses or key strokes.

Once the application is initiated, the viewer may locate a first desired target in the room 105 using electronic device 130 (block 370). The electronic device 130 may include a view finder for use in locating the first desired target. Alternatively, the electronic device 130 may display a targeting image, such as cross-hairs, a point, or so forth, to help the viewer locate the first desired target. To further assist the viewer in locating the first desired target, the electronic device 130 may display information related to the first desired target, such as a description of the first desired target. Once the viewer has located the first desired target, the viewer may press a key or button on the electronic device 130 to notify the electronic device 130 that the first desired target has been located.

With the first desired target located (block 370), the electronic device 130 may initiate the use of a sum of absolute differences (SAD) algorithm. The SAD algorithm may be used for motion estimation in video images. The SAD algorithm takes an absolute value of differences between pixels of an original image and a subsequent image to compute a measure of image similarity. The viewer may pan the electronic device 130 to a second desired target (block 510). Once again, the electronic device 130 may provide information to the viewer to assist in locating the second desired target.

As the viewer pans the electronic device 130 to the second desired target, the optical sensor 225 in the electronic device 130 may be capturing optical information for use in determining the starting position/orientation of the electronic device 130. Furthermore, an automatic gain control (AGC) circuit coupled to the optical sensor 225 may be providing gain control information to help maintain proper exposure levels of the optical information provided by the optical sensor 225. For example, the optical sensor 225 may be a charge coupled device (CCD) or an optical CMOS sensor of a still or video camera and the AGC circuit may be an exposure control circuit for the camera. The gain control information may be used to locate high luminosity objects encountered in the pan between the first desired target and the second desired target and may be compared against the luminosity map of the room 105. In lieu of the AGC circuit, the processor 210 may be used to compute gain control information from the optical information provided by the optical sensor 225. Additionally, changes in luminosity of the room 105, for example, as the brightness changes due to time of day, may result in changes in AGC luminosity information. Calibration may be performed at different times of the day and any changes in AGC luminosity information may be stored, such as in the electronic device 130 or in the information server 135 and may be provided to the electronic device 130.

Once the viewer locates the second desired target, the viewer may once again press a button or key to on the electronic device 130 to notify the electronic device 130 that the second desired target has been located. After locating the second desired target, the viewer may pan the electronic device 130 to a third desired target (block 515). Once again, the electronic device 130 may provide information to the viewer to assist in locating the third desired target. After the viewer locates the third desired target (block 515), the starting position/orientation of the electronic device 130 may then be computed by the electronic device 130 (block 385).

As the viewer pans the electronic device 130 to the third desired target, the AGC circuit continues to provide gain adjust information that may be used to locate high luminosity objects encountered as the electronic device 130 is panned to the third desired target. The located high luminosity objects encountered as the electronic device 130 is panned between the first desired target to the third desired target may be compared against the luminosity map of the room 105 help in more accurate determination of the starting position/orientation of the electronic device 130.

The computing of the starting position/orientation of the electronic device 130 may make use of a counting of a total number of pixels scanned by the optical sensor 225 of the electronic device 130 as it panned from the first desired target to the second desired target to the third desired target, which may be a function of the optical properties of the optical sensor 225 and any optical elements used in conjunction with the optical sensor 225. The computing of the starting position/orientation of the electronic device 130 may also make use of information downloaded from the information server 135, such as the physical dimensions of the walls in the room 105. The physical dimensions of the room 105 may be used to translate the optical distance traveled (the total number of pixels scanned by the optical sensor 225) into physical distance. The high luminosity objects located during the panning of the electronic device 130 may also be used in translating the optical distance to physical distance. Using this information, the electronic device 130 may be able to compute its starting position/orientation as a distance from the first wall and the second wall, for example.

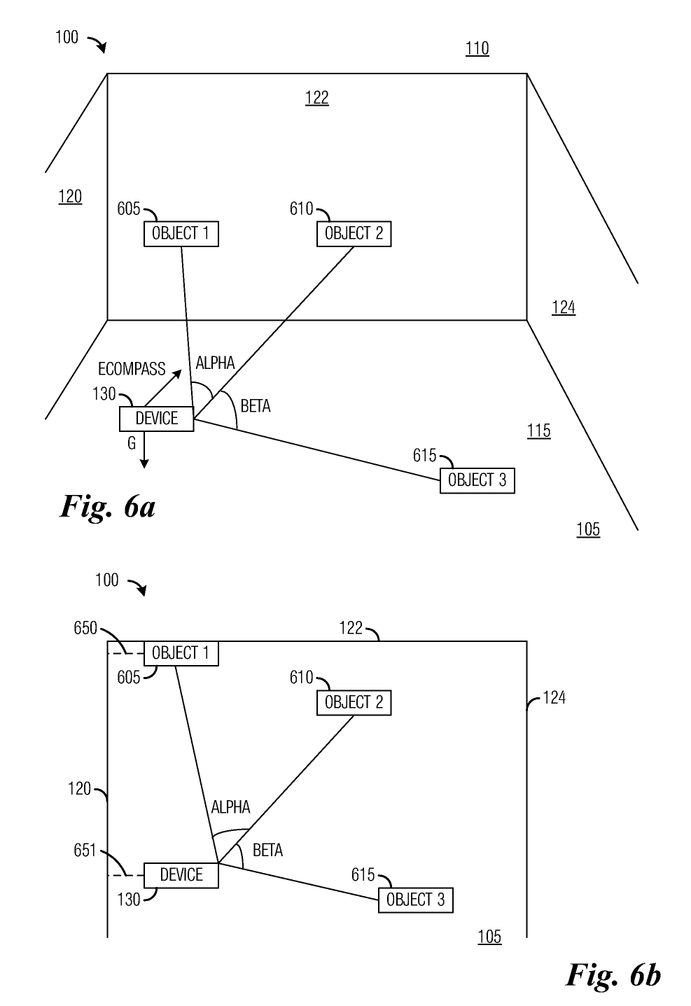

FIG. 6a illustrates an isometric view of a room, such as room 105, of a mobile augmented reality system, such as the mobile augmented reality system 100. In the room 105, there may be several objects, such as object “OBJECT 1” 605, object “OBJECT 2” 610, and object “OBJECT 3” 615. Objects may include physical parts of the room 105, such as walls, windows, doors, and so forth. Additionally, objects may include entities in the room 105, such as furniture, lights, plants, pictures, and so forth. It may be possible to determine a position/orientation of an electronic device, such as the electronic device 130, from the position of the objects in the room 105. For clarity, the viewer is omitted.

It may be possible to define an angle between the electronic device 130 and any two objects in the room. For example, an angle “ALPHA” may be defined as an angle between the object 605, the electronic object 130, and the object 610. Similarly, an angle “BETA” may be defined as an angle between the object 610, the electronic object 130, and the object 615. FIG. 6b illustrates a top view of the room 105.

When the electronic object 130 is closer to the objects 605 and 610 than the objects 610 and 615, then the angle “ALPHA” will be larger than the angle “BETA.” Correspondingly, when an image of the room 105 is taken, larger angles will tend to encompass a larger number of pixels of the image, while smaller angles will encompass a smaller number of pixels. This may be used to determine the position/orientation of the electronic device 130.

An approximate height of a virtual object to be rendered may be determined using a known distance of the electronic device 130 to a wall (line 650), a distance between the virtual object and the wall (line 651), the wall's distance above the ground, the direction of G as provided by an accelerometer, and a height of the electronic device 130 above the ground. Additional information required may be the room's width and length, which may be determined by measuring angles subtended by objects in the room.

FIG. 7 illustrates a sequence of events 700 for determining a starting position/orientation using image information provided by an optical sensor, such as the optical sensor 225, of an electronic device, such as the electronic device, used in a mobile augmented reality system, such as the mobile augmented reality system 100. The sequence of events 700 may be a variation of the sequence of events 350 for use in determining a starting position/orientation of the electronic device 130, making use of the room's feature information to measure angles to help in determining the starting position/orientation of the electronic device 130.

The determining of the starting position/orientation of the electronic device 130 may begin when a viewer holding the electronic device 130 enters the room 105 or when the information server 135 detects the electronic device 130 as the viewer holding the electronic device 130 approaches an entry into the room 105 (or vice versa). Until the determination of the starting position/orientation of the electronic device 130 is complete, the position/orientation of the electronic device 130 remains unknown.

After the information server 135 detects the electronic device 130, a wireless communications link may be established between the two and the electronic device 130 may be able to retrieve information pertaining to the room 105 (block 705). The information that the electronic device 130 may be able to retrieve from the information server 135 may include a layout of the room 105, dimensions of walls in the room 105, the location of various objects (real and/or virtual) in the room 105, as well as information to help the electronic device 130 determine the starting position/orientation for the electronic device 130. The information to help the electronic device 130 determine the starting/position may include number, location, type, and so forth, of desired targets in the room 105, and so on. The desired targets in the room 105 may be targets having fixed position, such as floor or ceiling corners of the room, as well as doors, windows, and so forth.

In addition to the information discussed above, the electronic device 130 may also retrieve a feature map of the room 105. The feature map may include the location of objects, preferably fixed objects, in the room 105, such as windows, doors, floor corners, ceiling corners, and so forth. With the information retrieved (block 705), the viewer may initiate the determining of the starting position/orientation of the electronic device 130. The viewer may start by holding or positioning the electronic device 130 as he/she would be holding it while normally using the electronic device 130 (block 360) and then initiating an application to determine the starting position/orientation of the electronic device (block 365). The viewer may initiate the application by pressing a specified button or key on the electronic device 130. Alternatively, the viewer may enter a specified sequence of button presses or key strokes.

Once the application is initiated, the viewer may locate a first desired target in the room 105 using electronic device 130 (block 370). The electronic device 130 may include a view finder for use in locating the first desired target. Alternatively, the electronic device 130 may display a targeting image, such as cross-hairs, a point, or so forth, to help the viewer locate the first desired target. To further assist the viewer in locating the first desired target, the electronic device 130 may display information related to the first desired target, such as a description of the first desired target. Once the viewer has located the first desired target, the viewer may press a key or button on the electronic device 130 to notify the electronic device 130 that the first desired target has been located.

With the first desired target located (block 370), the electronic device 130 may initiate the use of a sum of absolute differences (SAD) algorithm. The SAD algorithm may be used for motion estimation in video images. The SAD algorithm takes an absolute value of differences between pixels of an original image and a subsequent image to compute a measure of image similarity. The viewer may pan the electronic device 130 to a second desired target (block 710). Once again, the electronic device 130 may provide information to the viewer to assist in locating the second desired target.

As the viewer pans the electronic device 130 to the second desired target, the optical sensor 225 in the electronic device 130 may be capturing optical information for use in determining the starting position/orientation of the electronic device 130. Furthermore, the optical information provided by the optical sensor 225 may be saved in the form of images. The images may be used later to measure angles between various objects in the room to assist in the determining of the starting position/orientation of the electronic device 130. The optical information from the optical sensor 225 may be stored periodically as the viewer pans the electronic device 130. For example, the optical information may be stored ten, twenty, thirty, or so, times a second to provide a relatively smooth sequence of images of the room 105. The rate at which the optical information is stored may be dependent on factors such as amount of memory for storing images, resolution of the images, data bandwidth available in the electronic device 130, data processing capability, desired accuracy, and so forth.

Once the viewer locates the second desired target, the viewer may once again press a button or key to on the electronic device 130 to notify the electronic device 130 that the second desired target has been located. After locating the second desired target, the viewer may pan the electronic device 130 to a third desired target (block 715). As the viewer pans the electronic device to the third desired target, the optical information provided by the optical sensor 225 may be saved as images. Once again, the electronic device 130 may provide information to the viewer to assist in locating the third desired target.

After the viewer locates the third desired target (block 715), a unified image may be created from the images stored during the panning of the electronic device 130 (block 720). A variety of image combining algorithms may be used to combine the images into the unified image. From the unified image, angles between the electronic device 130 and various objects in the room 105 may be measured (block 725). An estimate of the angles may be obtained by counting a number of pixels between the objects, with a larger number of pixels potentially implying a larger angle and a close proximity between the electronic device 130 and the objects. Similarly, a smaller number of pixels potentially implies a smaller angle and a greater distance separating the electronic device 130 and the objects. The number of pixels may be a function of the optical properties of the optical sensor 225 and any optical elements used in conjunction with the optical sensor 225. The starting position/orientation of the electronic device 130 may then be determined with the assistance of the measured angles (block 385).

The computing of the starting position/orientation of the electronic device 130 may make use of a counting of a total number of pixels scanned by the optical sensor 225 of the electronic device 130 as it panned from the first desired target to the second desired target to the third desired target, which may be a function of the optical properties of the optical sensor 225 and any optical elements used in conjunction with the optical sensor 225. The computing of the starting position/orientation of the electronic device 130 may also make use of information downloaded from the information server 135, such as the physical dimensions of the walls in the room 105. The physical dimensions of the room 105 may be used to translate the optical distance traveled (the total number of pixels scanned by the optical sensor 225) into physical distance. The measured angles computed from the unified image may also be used in translating optical distance into physical distance. Using this information, the electronic device 130 may be able to compute its starting position/orientation as a distance from the first wall and the second wall, for example.

There may be situations wherein the use of luminosity maps and measured angles may not yield sufficient accuracy in determining the position/orientation of the electronic device 130. For example, rooms without windows and lights and so forth, the use of luminosity maps may not yield adequately large luminosity peaks to enable a sufficiently accurate determination of the position/orientation of the electronic device 130. Furthermore, in dimly lit rooms, there may be insufficient light to capture images with adequate resolution to enable the measuring (estimating) of angles between the electronic device 130 and objects. Therefore, there may be a need to utilize portions of light spectrum outside of visible light to determine the position/orientation of the electronic device 130. This may be referred to as hyperspectral imaging.

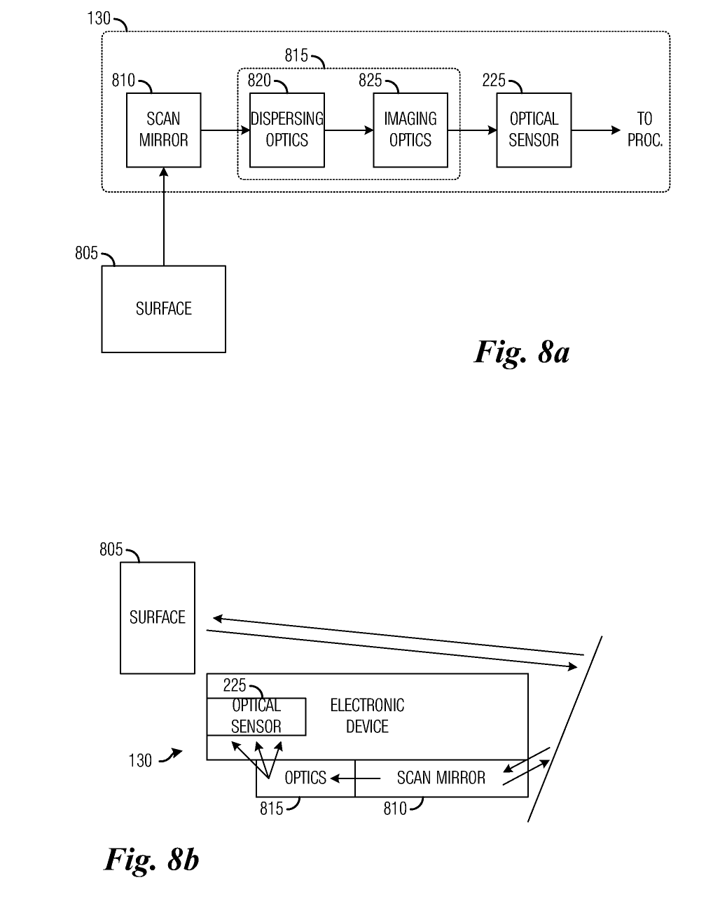

FIG. 8a illustrates a high-level view of an electronic device, such as the electronic device 130, of a mobile augmented reality system, such as the mobile augmented reality system 100, wherein the electronic device 130 makes use of hyperspectral imaging to determine position/orientation of the electronic device 130. In general, people, objects, surfaces, and so forth, have hyperspectral signatures that may be unique. The hyperspectral signatures may then be used to determine the position/orientation of the electronic device 130 in the mobile augmented reality system 100.

The electronic device 130 may capture hyperspectral information from a surface 805 for use in determining position/orientation of the electronic device 130. The surface 805 may include walls, ceilings, floors, objects, and so forth, of a room, such as the room 105, of the mobile augmented reality system 100.

The electronic device 130 includes a scan mirror 810 that may be used to redirect light (including light outside of the visible spectrum) from the surface 805 through an optics system 815. The scan mirror 810 may be a mirror (or a series of mirrors arranged in an array) that moves along one or more axes to redirect the light to the optics system 815. Examples of a scan mirror may be a flying spot mirror or a digital micromirror device (DMD). The optics system 815 may be used to perform optical signal processing on the light. The optics system 815 includes dispersing optics 820 and imaging optics 825. The dispersing optics 820 may be used to separate the light into its different component wavelengths. Preferably, the dispersing optics 820 may be able to operate on light beyond the visible spectrum, such as infrared and ultraviolet light. The imaging optics 825 may be used re-orient light rays into individual image points. For example, the imaging optics 825 may be used to re-orient the different component wavelengths created by the dispersing optics 820 into individual image points on the optical sensor 225. The optical sensor 225 may then detect energy levels at different wavelengths and provide the information to the processor 210.

FIG. 8b illustrates an exemplary electronic device 130, wherein the electronic device 130 makes use of hyperspectral imaging to determine position/orientation of the electronic device 130. The electronic device 130 includes the scan mirror 810 and the optics system 815. The scan mirror 810 and the optics system 815 may be dual-use, wherein the scan mirror 810 and the optics system 815 may be used in the capturing of hyperspectral information for use in determining the position/orientation of the electronic device 130. Additionally, the scan mirror 810 and the optics system 815 may also be used to display images.

For example, the electronic device 130 may be used to display images in the mobile augmented reality system 100 for a majority of the time. While displaying images, the processor 210 may be used to provide image data and mirror control instructions to the scan mirror 815 to create the images. The optics system 815 may be used to perform necessary optical processing to properly display images on the surface 805. Periodically, the electronic device 130 may switch to an alternate mode to capture hyperspectral information. In the alternate mode, the processor 210 may issue mirror control instructions to the scan mirror 810 so that it scans in a predetermined pattern to direct hyperspectral information to the optical sensor 225 through the optics system 815. Preferably, the alternate mode is of sufficiently short duration so that viewers of the mobile augmented reality system 100 may not notice an interruption in the displaying of images by the electronic device 130.

FIG. 9 illustrates a sequence of events 900 for determining a starting position/orientation using hyperspectral information provided by an optical sensor, such as the optical sensor 225, of an electronic device, such as the electronic device, used in a mobile augmented reality system, such as the mobile augmented reality system 100. The sequence of events 900 may be a variation of the sequence of events 350 for use in determining a starting position/orientation of the electronic device 130, making use of the room's hyperspectral information to help in determining the starting position/orientation of the electronic device 130.

The determining of the starting position/orientation of the electronic device 130 may begin when a viewer holding the electronic device 130 enters the room 105 or when the information server 135 detects the electronic device 130 as the viewer holding the electronic device 130 approaches an entry into the room 105 (or vice versa). Until the determination of the starting position/orientation of the electronic device 130 is complete, the position/orientation of the electronic device 130 remains unknown.

After the information server 135 detects the electronic device 130, a wireless communications link may be established between the two and the electronic device 130 may be able to retrieve information pertaining to the room 105 (block 905). The information that the electronic device 130 may be able to retrieve from the information server 135 may include a layout of the room 105, the dimensions of walls in the room 105, the location of various objects (real and/or virtual) in the room 105, as well as information to help the electronic device 130 determine the starting position/orientation for the electronic device 130. The information to help the electronic device 130 determine the starting/position may include number, location, type, and so forth, of desired targets in the room 105, and so on. The desired targets in the room 105 may be targets having fixed position, such as floor or ceiling corners of the room, as well as doors, windows, and so forth.

In addition to the information discussed above, the electronic device 130 may also retrieve a hyperspectral map of the room 105. The hyperspectral map may include the hyperspectral signatures of various objects in the room 105, such as windows, lights, and so forth. With the information retrieved (block 905), the viewer may initiate the determining of the starting position/orientation of the electronic device 130. The viewer may start by holding or positioning the electronic device 130 as he/she would be holding it while normally using the electronic device 130 (block 360) and then initiating an application to determine the starting position/orientation of the electronic device (block 365). The viewer may initiate the application by pressing a specified button or key on the electronic device 130. Alternatively, the viewer may enter a specified sequence of button presses or key strokes.

Once the application is initiated, the viewer may locate a first desired target in the room 105 using electronic device 130 (block 370). The electronic device 130 may include a view finder for use in locating the first desired target. Alternatively, the electronic device 130 may display a targeting image, such as cross-hairs, a point, or so forth, to help the viewer locate the first desired target. To further assist the viewer in locating the first desired target, the electronic device 130 may display information related to the first desired target, such as a description of the first desired target. Once the viewer has located the first desired target, the viewer may press a key or button on the electronic device 130 to notify the electronic device 130 that the first desired target has been located.

With the first desired target located (block 370), the electronic device 130 may initiate the use of a sum of absolute differences (SAD) algorithm. The SAD algorithm may be used for motion estimation in video images. The SAD algorithm takes an absolute value of differences between pixels of an original image and a subsequent image to compute a measure of image similarity. The viewer may pan the electronic device 130 to a second desired target (block 910). Once again, the electronic device 130 may provide information to the viewer to assist in locating the second desired target.

As the viewer pans the electronic device 130 to the second desired target, the optical sensor 225 in the electronic device 130 may be capturing hyperspectral information for use in determining the starting position/orientation of the electronic device 130. The hyperspectral information may be used to locate objects of known hyperspectral signatures encountered in the pan between the first desired target and the second desired target and may be compared against the hyperspectral map of the room 105.

Once the viewer locates the second desired target, the viewer may once again press a button or key to on the electronic device 130 to notify the electronic device 130 that the second desired target has been located. After locating the second desired target, the viewer may pan the electronic device 130 to a third desired target (block 915). Once again, the electronic device 130 may provide information to the viewer to assist in locating the third desired target. After the viewer locates the third desired target (block 915), the starting position/orientation of the electronic device 130 may then be computed by the electronic device 130 (block 385).

As the viewer pans the electronic device 130 to the third desired target, the optical sensor 225 continues to provide hyperspectral information that may be used to locate objects of known hyperspectral signatures encountered as the electronic device 130 is panned to the third desired target. The located objects of known hyperspectral signatures encountered as the electronic device 130 is panned between the first desired target to the third desired target may be compared against the hyperspectral map of the room 105 help in more accurate determination of the starting position/orientation of the electronic device 130.

The computing of the starting position/orientation of the electronic device 130 may make use of a counting of a total number of pixels scanned by the optical sensor 225 of the electronic device 130 as it panned from the first desired target to the second desired target to the third desired target, which may be a function of the optical properties of the optical sensor 225 and any optical elements used in conjunction with the optical sensor 225. The computing of the starting position/orientation of the electronic device 130 may also make use of information downloaded from the information server 135, such as the physical dimensions of the walls in the room 105. The physical dimensions of the room 105 may be used to translate the optical distance traveled (the total number of pixels scanned by the optical sensor 225) into physical distance. The located objects having known hyperspectral signatures found during the panning of the electronic device 130 may also be used in translating the optical distance to physical distance. Using this information, the electronic device 130 may be able to compute its starting position/orientation as a distance from the first wall and the second wall, for example.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for calculating a starting position/orientation of an electronic device, the method comprising:
retrieving a specification of an environment of the electronic device;
capturing optical information of the environment of the electronic device; and
computing the starting position/orientation from the captured optical information and the specification.

2. The method of claim 1, wherein retrieving the specification comprises retrieving the specification from an information server.

3. The method of claim 2, wherein retrieving the specification further comprises prior to retrieving the specification from the information server, detecting the presence of the information server.

4. The method of claim 1, wherein capturing optical information comprises:
panning the electronic device about the environment; and
capturing optical information as the electronic device pans.

5. The method of claim 4, wherein panning the electronic device comprises:
bringing the electronic device into a specified position;
initiating a capturing sequence; and
panning the electronic device between a first specified position and a second specified position.

6. The method of claim 1, wherein capturing optical information comprises retrieving luminosity information from an image sensor.

7. The method of claim 6, wherein retrieving the luminosity information comprises retrieving automatic gain control information from the image sensor.

8. The method of claim 6, wherein computing the starting position comprises:
locating high luminosity objects in the environment;
processing the luminosity information from the image sensor; and
computing the starting position/orientation from a difference between the specification and the processed luminosity information.

9. The method of claim 8, wherein processing the luminosity information comprises applying a Hough transform to the luminosity information.

10. The method of claim 1, wherein capturing optical information comprises capturing a sequence of optical images with an optical sensor in the electronic device.

11. The method of claim 10, wherein computing the starting position comprises:
creating a unified image from the sequence of optical images;
computing a first angle between the electronic device and a first pair of objects in the environment from the unified image;
computing a second angle between the electronic device and a second pair of objects in the environment from the unified image; and
computing the starting position/orientation from the first angle, the second angle, and the specification.

12. The method of claim 1, wherein capturing optical information comprises retrieving hyperspectral information from a hyperspectral sensor in the electronic device.

13. The method of claim 12, wherein computing the starting position comprises:
locating objects of known hyperspectral signature in the environment;
processing the hyperspectral information from the hyperspectral sensor; and
computing the starting position/orientation from a difference between the specification and the processed hyperspectral information.

14. The method of claim 1, wherein computing the starting position/orientation also makes use of position information from a positional sensor.

15. A method for displaying an image using a portable display device, the method comprising:
computing a position/orientation for the portable display device;
rendering the image using the computed position/orientation for the portable display device;
displaying the image; and
in response to a determining that the portable display device has changed position/orientation,
computing a new position/orientation for the portable display device, wherein the computing makes use of optical position information captured by an optical sensor in the portable display device, and
repeating the rendering and the displaying using the computed new position/orientation.

16. The method of claim 15, further comprising after displaying the image, continuing to display the image in response to a determining that the portable display device has not changed position/orientation.

17. The method of claim 15, wherein rendering the image comprises adjusting the image to correct for a point of view determined by the computed position/orientation.

18. The method of claim 15, wherein computing the new position/orientation also makes use of position/orientation information from a positional sensor.

19. The method of claim 15, wherein the optical position information is selected from the group consisting of: luminosity information, visual image of a specified object, hyperspectral image information, and combinations thereof.

20. An electronic device comprising:
a projector configured to display an image;
a position sensor configured to provide position and orientation information of the electronic device;
an optical sensor configured to capture optical information for use in computing a position and orientation of the electronic device; and
a processor coupled to the projector, to the position sensor, and to the optical sensor, the processor configured to process the optical information and the position and orientation information to compute the position and orientation of the electronic device and to render the image using the position and orientation of the electronic device.

21. The electronic device of claim 20, wherein a scan mirror device is used to display the image and to redirect optical information to the optical sensor.

22. The electronic device of claim 20, wherein the projector utilizes the optical sensor to display the image, and wherein the projector is not displaying the image when the optical sensor captures optical information for use in computing the position and orientation of the electronic device.
